(19) United States
(12) Patent Application Publication
(10) Pub. No.: US 2006/0096941 A1
(43) Pub. Date: May 11, 2006

(54) Construction device comprising a mast having a pivotable deflecting device

(76) Inventor: Erwin Stoetzer, Aichach (DE)

Correspondence Address: JACOBSON HOLMAN PLLC, 400 SEVENTH STREET N.W., SUITE 600, WASHINGTON, DC, 20004, US

(21) Appl. No.: 11/264,012

(22) Filed: Nov. 2, 2005

(30) Foreign Application Priority Data
Nov. 8, 2004 (EP) 04 026 490.5

(51) Int. Cl. B66C 23/70

(52) U.S. Cl. 212/347

(57) ABSTRACT

The invention relates to a construction device comprising a mast, a deflecting device arranged on the head of the mast for guiding at least one cable or one lead, and a pivot device, by means of which the deflecting device can be pivoted from an operating position into a transport position. The deflecting device has two deflecting rollers, one of which is pivotably supported with respect to the other.

The invention relates to a construction device according to the preamble of claim 1 comprising a mast, a deflecting device arranged on the head of the mast for guiding at least one cable or one lead, wherein the deflecting device includes a first front deflecting roller and a second rear deflecting roller, and with a pivot device, by means of which the deflecting device can be pivoted from an operating position into a transport position.

A construction device according to the preamble is known from DE 101 23 403 A1. This printed publication teaches a construction apparatus having a mast, to the upper end of which a mast head is attached. This mast head has at least two cable deflecting rollers, by means of which working cables of the construction apparatus are guided around the mast head. In order to facilitate the transport of the entire construction apparatus the mast head together with the two deflecting rollers can be pivoted on the mast by a pivot device between a working position and a transport position. As a result, in particular the vertical clearance of the construction apparatus can be reduced when the mast is placed into an approximately horizontal position for the transport of the construction apparatus.

The object of the invention is to provide a construction device that is particularly compact and easy to transport.

The object is solved in accordance with the invention by a construction device having the features of claim 1. Preferred embodiments are stated in the dependent claims.

The construction device according to the invention is characterized in that the front deflecting roller is pivotably supported with respect to the rear deflecting roller.

A fundamental idea of the invention may be seen in the fact that by means of the pivot device the relative position of the front deflecting roller can be altered with respect to the rear deflecting roller, i.e. by means of the pivot device the two deflecting rollers can be pivoted to a different degree. As a result it is possible, to bring the two deflecting rollers independent of each other into a particularly favourable position with regard to the transport dimensions of the construction device, whereby a construction device can be achieved that is particularly compact and easy to transport.

Advantageously, the cable or the lead runs into the deflecting device on the front deflecting roller and runs out of the deflecting device on the rear deflecting roller. By preference, along the stretch of the cable the rear deflecting roller is arranged on the winch-facing side and the front deflecting roller is arranged on the load-facing side on the head of the mast. It is suitable for the cable or the lead to run into the front deflecting roller and out of the rear deflecting roller at least approximately parallel to the longitudinal direction of the mast. More particularly, the construction device can be designed such that the cable is guided from the front deflecting roller directly to a load, such as for example a soil working implement, i.e. there are no further deflecting rollers provided along the stretch of the cable between this deflecting roller and the load. The construction device preferably serves to work on the soil.

In principle, provision can be made for both the front deflecting roller and the rear deflecting roller to be pivotable by means of the pivot device. However, it is particularly preferred that the rear deflecting roller is supported in a fixed manner on the mast. This embodiment is based on the consideration that when the mast is folded the transport dimensions of the construction device, and in particular its vertical clearance, are in most cases determined by the position of the front deflecting roller on the mast alone. In contrast, in most cases the rear deflecting roller does not protrude from the overall cross section of the construction device and is therefore negligible in its contribution to the transport dimensions of the construction device. For this reason it may be of advantage that the front deflecting roller alone can be pivoted by means of the pivot device, whereas the rear deflecting roller is arranged in a non-pivotable manner on the mast. Since the number of the deflecting rollers to be operated is reduced in this case, the driving devices of the pivot device can be designed with a correspondingly decreased drive power so that a particularly economical construction device can be attained. As the rear deflecting roller does not perform a pivoting movement. on the mast according to this embodiment, there is no need for a corresponding pivoting range to be kept free on the mast, whereby the external dimensions of the construction device can be reduced further. The fixed support of the rear deflecting roller on the mast is to be understood in particular in that the deflecting roller is in fact rotatable about an axis of rotation but the position of this axis of rotation is fixed with respect to the mast.

A construction device having a particularly simple design is characterized in that the pivot device has a boom, which is pivotably hinged to the head of the mast and on which the front deflecting roller is rotatably supported. By preference, the boom can be pivoted on the mast about a pivot axis, which extends at least approximately parallel to the axis of rotation of the front and/or rear deflecting roller.

A particularly reliable operation of the pivot device is rendered possible in that the pivot device has a hydraulic cylinder, which is hinged on its one side to the boom and on its other side to the head of the mast. Here a particularly compact pivot device can be achieved in that, at least in the operating position of the deflecting device, the longitudinal axis of the hydraulic cylinder is arranged at least approximately parallel to the stretch of the cable or the stretch of the lead between the front and the rear deflecting roller. For adjustment purposes use can also be made of a spindle drive or a chain drive or a different kind of drive.

Furthermore, a construction device having a particularly simple design is provided in that the hinge axes of the hydraulic cylinder extend at least approximately parallel to the axes of rotation of the deflecting rollers. Here the hinge axes are understood as the axes of the articulation of the hydraulic cylinder on the boom and on the mast. To achieve a particularly compact construction device provision can be made in particular for one of the two hinge axes to coincide at least approximately with the axis of rotation of the rear deflecting roller.

In the operating position of the deflecting device the front deflecting roller suitably projects forwards on the mast and in the transport position it is offset backwards, especially with respect to the front side of the mast. A particularly low vertical clearance in the transport position accompanied by a particularly simple course of the cable in the operating position may be provided in that in the operating position of the deflecting device the axis of rotation of the front deflecting roller is disposed in front of the longitudinal axis of the mast and in the transport position it is disposed on or behind the longitudinal axis. The longitudinal axis can be understood as any chosen axis extending longitudinally through the mast within the mast cross section. More particularly, the longitudinal axis can extend through the centre of gravity of the mast. By preference, it constitutes an axis of symmetry of the mast.

A construction device that is particularly suitable for working on the soil is characterized in that a guiding device for guiding a soil working implement longitudinally to the mast is provided. The soil working implement can be constituted for example by an auger or also by a cutting device. The guiding device can include in particular a drive for rotatably driving the soil working implement about its longitudinal axis. In order to be able to fix the soil working implement on the cable in a particularly simple way it is advantageous for the front deflecting roller to be aligned tangentially with the longitudinal axis of the soil working implement in the operating position of the deflecting device. More particularly, this can be understood in that one line tangent to the front deflecting roller lies on an extension of the longitudinal axis of the soil working implement.

A further advantageous embodiment of the invention resides in the fact that both in the operating position and in the transport position of the deflecting device the front deflecting roller is arranged above the rear deflecting roller as seen in the longitudinal direction of the mast. By this it is understood that in both positions the front deflecting roller is located further away from the mast base than the rear deflecting roller. As a result of such an arrangement of the two rollers with respect to each other particularly short adjusting ranges of the pivot device and consequently a particularly simple design of the driving device of the pivot device are rendered possible.

Furthermore, according to the invention it is particularly preferred that the rear deflecting roller is supported on the head of the mast by means of a stationary boom, the said stationary boom being in particular of shorter length than the boom of the pivot device.

Another particularly preferred embodiment of the invention resides in the fact that an auxiliary roller for guiding an auxiliary cable is provided, which is pivotably supported by means of an auxiliary boom on the pivot device, in particular on the boom. In addition to the auxiliary roller further rollers can be provided on the head of the mast for guiding and deflecting the auxiliary cable, and in this case the axes of rotation of these further rollers preferably coincide with the axes of rotation of the front and/or rear deflecting roller. On account of the pivotable support of the auxiliary roller the transport dimensions of the construction device can be reduced further.

To pivot the auxiliary roller an auxiliary hydraulic cylinder may be provided for example, which is hinged on one side to the auxiliary boom and on the other side to the boom. However, a pivoting movement of the auxiliary roller can also be brought about for example through the gravity effect acting on the auxiliary roller and the auxiliary boom during the pivoting of the pivot device and/or the mast. It is particularly preferred that a rigid locking bar is provided, through which the auxiliary boom can be fixed on the boom. This locking bar is suitably hinged on its one side to the auxiliary boom and on its other side it can be attached to the boom so as to fix the auxiliary boom. Alternatively, the locking bar can also be hinged to the boom and be able to be attached to the auxiliary boom.

In addition it is preferred in accordance with the invention that a construction vehicle is provided, on which the mast is arranged preferably in a pivotable manner. It is suitable for the mast to be pivotable from a vertical operating position, in which it extends at least approximately in the vertical direction, into a folded transport position, in which the mast extends at least approximately in the horizontal direction.

In the following the invention will be described in greater detail by way of preferred embodiments schematically shown in the drawings, wherein:

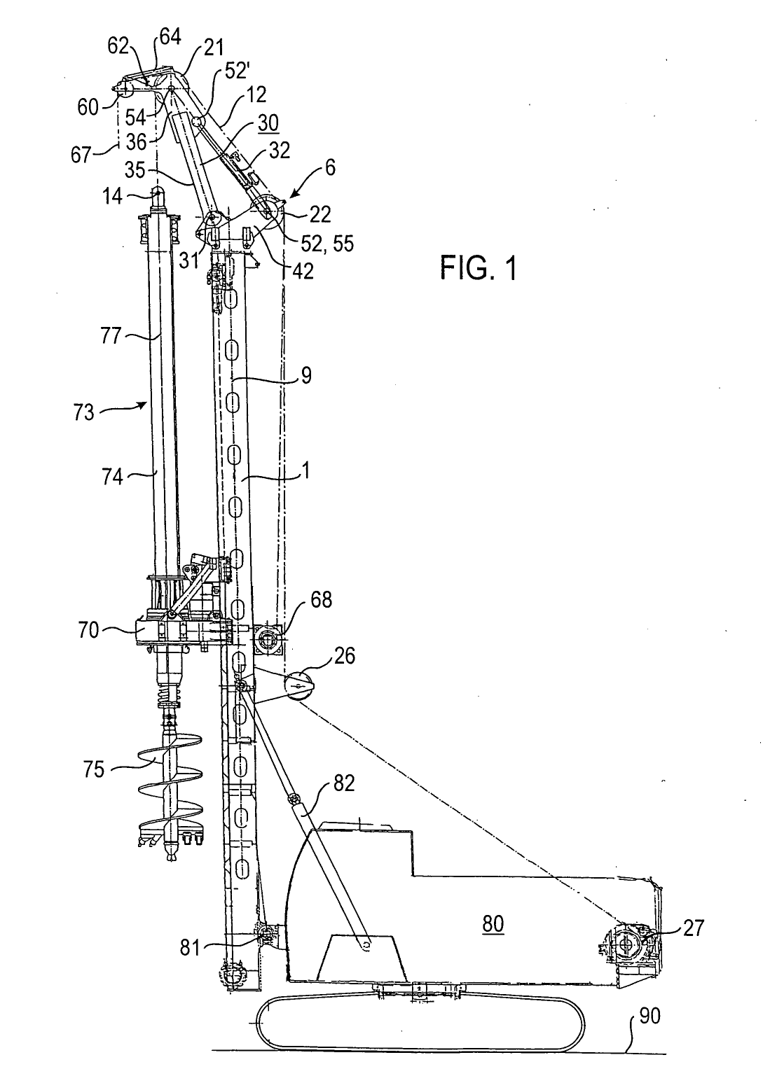

FIG. 1 shows a partly sectional side view of a construction device according to the invention, in which the mast and the deflecting device are located in the operating position; and

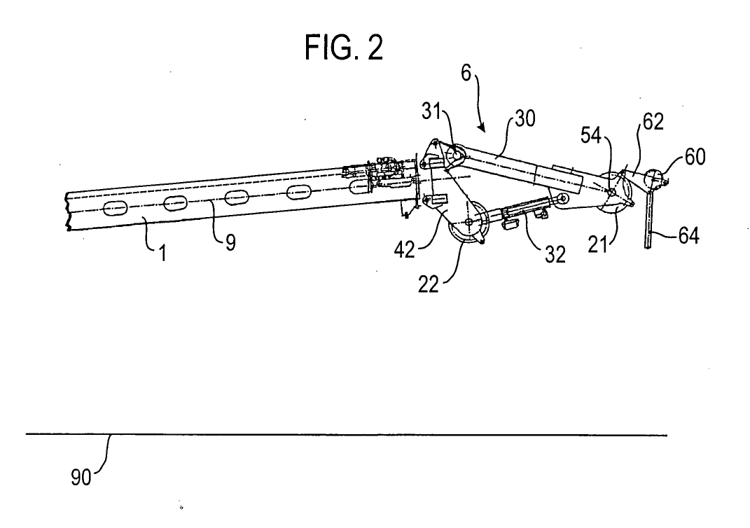

FIG. 2 shows a partly sectional side view of the head-side mast end of the construction device of FIG. 1, in which the mast and the deflecting device are located in the transport position.

An embodiment of a construction device according to the invention is shown in FIG. 1 and in cut-out in FIG. 2. The construction device includes a construction vehicle 80 designed as a crawler running gear, to which a mast 1 designed as a leader is pivotably hinged by means of a pivot hinge 81 about a pivot axis that extends substantially in the horizontal direction. For the active pivoting of the mast 1 a hydraulic pivot cylinder 82 is provided, which is hinged on its one side to the lower half of the mast 1 and on its other side to the construction vehicle 80. In the illustration shown in FIG. 1 the mast 1 is located in a vertical operating position, in which the longitudinal axis 9 of the mast 1 extends substantially in the vertical direction to the soil surface 90. In this operating position the construction device is provided for working on the soil.

In the illustration shown in FIG. 2 the mast 1 is pivoted into a transport position with reduced external dimensions. In this transport position the longitudinal axis 9 extends substantially in the horizontal direction with respect to the soil surface 90.

The construction device additionally includes a soil working implement 73 consisting of an auger 75 and a telescopic drill rod designed as a Kelly rod 74, on which the auger 75 is arranged on the ground-facing side. The soil working implement 73 is displaceably guided on its Kelly rod 74 by means of a guiding device 70 disposed on the mast 1. Here provision is made for a displacement in the direction of the longitudinal axis 77 of the soil working implement 73 that extends at least approximately parallel to the longitudinal axis 9 of the mast 1. The guiding device 70 additionally includes a rotary drive, not specifically indicated, to rotatably drive the soil working implement 73 about its longitudinal axis 77.

To retain the soil working implement 73 the construction device has a cable 12 designed as a steel cable that is connected to the soil working implement 73 at a point of attachment 14 provided at the top of the soil working implement 73. From the point of attachment 14 the cable 12 runs to a first front deflecting roller 21 that is rotatably supported on the head 6 of the mast 1, i.e. at the upper end of the mast 1. The cable 12 is guided around this front deflecting roller 21 and runs from there to a rear deflecting roller 22 that is equally arranged on the head 6 of the mast 1. Likewise, the cable 12 is guided around this rear deflecting roller 22 from where it runs via another deflecting roller 26 arranged in the lower half of the mast 1 to a cable winch 27 located at the rear of the construction vehicle 80.

Whereas in FIG. 1 the cable 12 extends between the front deflecting roller 21 and the point of attachment 14 as well as between the rear deflecting roller 22 and the further deflecting roller 26 at least approximately in the vertical direction and parallel to the longitudinal axis 9 of the mast 1, the cable 12 extends between the two deflecting rollers 21, 22 at an angle to the longitudinal axis 9 and to the soil surface 90. The deflecting rollers 21, 22 are rotatably supported about axes of rotation 54, 55 that extend approximately parallel to the soil surface 90, i.e. in the horizontal direction.

The rear deflecting roller 22 is supported via a stationary boom 42 in a spatially fixed and rotatable manner on the mast 1. The front deflecting roller 21 in turn is pivotably supported on the mast 1. For the purpose of pivotably supporting the front deflecting roller 21 a boom 30 is provided, which is hinged at its one end by means of a pivot hinge 31 to the head of the mast 1. At the other end of the boom 30 the front deflecting roller 21 is rotatably supported. The hinge axis of the pivot hinge 31 extends horizontally and at least approximately parallel to the axes of rotation 54, 55 of the two deflecting rollers 21, 22.

In the mode shown in FIG. 1 the front deflecting roller 21 is located in the operating position, in which this roller 21 projects forwards on the mast 1 and is aligned tangentially with the longitudinal axis 77 of the soil working implement 73. In the transport position shown in FIG. 2, however, the front deflecting roller 21 is pivoted about the pivot hinge 31 into a rear transport position, in which the axis of rotation 54 of the front deflecting roller 21 is offset backwards with respect to the longitudinal axis 9 of the mast 1. In this transport position the front deflecting roller 21 no longer projects from the mast 1 but is arranged in a rear-offset manner with respect to the latter. As can be gathered from FIG. 2, in this transport position with folded mast 1 the vertical clearance of the construction device is reduced.

For the active pivoting of the boom 30 with the front deflecting roller 21 a hydraulic cylinder 32 is provided that is hinged at the end of its piston rod to the boom 30 and at the end of its cylinder casing to the stationary boom 42. Here the hinge axis 52 of the articulation of the hydraulic cylinder 32 to the stationary boom 42 coincides with the axis of rotation 55 of the rear deflecting roller 22. The hinge axis 52′ of the articulation of the hydraulic cylinder 32 to the boom 30 extends parallel to the axes of rotation 54, 55 of the two deflecting rollers 21, 22.

The boom 30 is designed in two parts and includes a bar-shaped boom pole 35, on which the pivot hinge 31 is arranged, and a broadened bearing plate 36, on which the front deflecting roller 21 is supported and the hydraulic cylinder 32 is arranged. The hydraulic cylinder 32 is arranged in such a manner that, both in the operating position and in the transport position of the front deflecting roller 21, its longitudinal axis extends at least approximately parallel to the cable 12 between the two deflecting rollers 21, 22.

In accordance with the invention the pivoting movement of the mast 1 is generally independent of the pivoting movement of the deflecting device, in particular of the front deflecting roller 21, i.e. the mast 1 may be located in its operating position for example while the front deflecting roller 21 may be in its transport position and vice versa. However, it is particularly preferred that the deflecting device 21 is moved simultaneously with the mast 1 into the operating position or the transport position.

In addition to the cable 12 the construction device also includes an auxiliary cable 67 that can be actuated by means of an auxiliary winch 68 arranged on the mast 1. From the auxiliary winch 68 the auxiliary cable 67 runs via further rollers on the mast head 6, which are not depicted in the Figures and whose axes of rotation coincide with the axes of rotation 54, 55 of the deflecting rollers 21, 22, to an auxiliary roller 60 and around this roller to a load, not depicted here either. The auxiliary roller 60 is rotatably supported on an auxiliary boom 62 that is in turn pivotably supported on the bearing plate 36 of the boom 30. To fix the pivotable auxiliary boom 62 and the auxiliary roller 60 a locking bar 64 of fixed length is hinged to the auxiliary boom 62, which can be attached to the bearing plate 36 of the boom 30. Once the locking bar 64 is attached the auxiliary boom 62 is supported in two ways on the boom and therefore fixed in its position.

In the mode shown in FIG. 1 the locking bar 64 is fixed to the boom 30, as a consequence of which the position of the auxiliary boom 62 with the auxiliary roller 60 is fixed with respect to the boom 30. The auxiliary boom 62 and the locking bar 64 are dimensioned such that, when the locking bar 64 is attached and the front deflecting roller 21 and the mast 1 are located in the operating position, the axis of rotation of the auxiliary roller 60 lies at least approximately on the same height as the axis of rotation 54 of the front deflecting roller 21.

In the mode depicted in FIG. 2 the locking bar 64 is detached from the boom 30 and the auxiliary boom 62 together with the auxiliary roller 60 are thus released for a pivoting movement. As a result of the effect of gravity the auxiliary boom 62 reaches a position in which it projects from the head of the mast 1. According to the invention the front side of the mast 1 can be understood in particular as the side of the mast facing towards the soil working implement 73 and/or facing away from the construction vehicle 80.

1. Construction device comprising
a mast,
a deflecting device arranged on the head of the mast for guiding at least one cable or one lead,
a first front deflecting roller and a second rear deflecting roller provided on the deflecting device, and
a pivot device, by means of which the deflecting device can be pivoted from an operating position into a transport position,
wherein the front deflecting roller is pivotably supported with respect to the rear deflecting roller.

2. Construction device according to claim 1, wherein the rear deflecting roller is supported in a fixed manner on the mast.

3. Construction device according to claim 1, wherein the pivot device has a boom, which is pivotably hinged to the head of the mast and on which the front deflecting roller is rotatably supported.

4. Construction device according to claim 3, wherein the pivot device has a hydraulic cylinder, which is hinged on its one side to the boom and on its other side to the head of the mast.

5. Construction device according to claim 4, wherein the hinge axes of the hydraulic cylinder extend at least approximately parallel to the axes of rotation of the deflecting rollers, and in particular one of the two hinge axes coincides -with the axis of rotation of the rear deflecting roller.

6. Construction device according to claim 1, wherein, in the operating position of the deflecting device, the axis of rotation of the front deflecting roller is disposed in front of the longitudinal axis of the mast and in the transport position it is disposed on or behind the longitudinal axis.

7. Construction device according to claim 1, wherein
a guiding device for guiding a soil working implement longitudinally to the mast is provided and
in the operating position of the deflecting device the front deflecting roller is aligned tangentially with the longitudinal axis of the soil working implement.

8. Construction device according to claim 1, wherein both in the operating position and in the transport position of the deflecting device the front deflecting roller is arranged above the rear deflecting roller as seen in the longitudinal direction of the mast.

9. Construction device according to claim 1, wherein the rear deflecting roller is supported on the head of the mast by means of a stationary boom, the said stationary boom being in particular of shorter length than the boom of the pivot device.

10. Construction device according to claim 1, wherein an auxiliary roller for guiding an auxiliary cable is provided, which is pivotably supported by means of an auxiliary boom on the pivot device, in particular on the boom.

11. Construction device according to claim 10, wherein a rigid locking bar is provided, with which the auxiliary boom can be fixed on the boom.

12. Construction device according to claim 1, wherein a construction vehicle is provided, on which the mast is arranged preferably in a pivotable manner.
